(19) United States
(12) Patent Application Publication
(10) Pub. No.: US 2003/0105837 A1
(43) Pub. Date: Jun. 5, 2003

(54) Interception for optimal caching of distributed applications

(76) Inventors: Yury Kamen, Foster City, CA (US); Bruce K. Daniels, Capitola, CA (US); Robert N. Goldberg, Emerald Hills, CA (US); Syed M. Ali, Sunnyvale, CA (US); Peter A. Yared, San Francisco, CA (US)

Correspondence Address: ROSENTHAL & OSHA L.L.P., Suite 4550, 700 Louisiana, Houston, TX, 77002, US

(21) Appl. No.: 09/997,989

(22) Filed: Nov. 30, 2001

(51) Int. Cl. G06F 7/00

(52) U.S. Cl. 709/220

(57) ABSTRACT

An automatic caching method for a distributed application having a client and a server includes intercepting a call between the client and the server in order to collect information about objects accessed on the server during the call, prefetching data from an object based on collected information, placing data into a client cache, synchronizing marked calls with the server, and synchronizing the client cache with the server.

### CROSS-REFERENCE TO RELATED APPLICATIONS

This application contains disclosure related to U.S. patent application Ser. No. ______, entitled “Transparent Injection of Intelligent Proxies into Existing Distributed Applications.”

### BACKGROUND OF INVENTION

Modem enterprise applications are typically implemented as multi-tier systems. Multi-tier systems serve the end-user through a chain of client/server pairs. In general, they include a user interface at the front end, a database at the back end, and an application server in between the user interface and the database. Depending on the component providing the user interface, an additional middle tier may exist between the user interface and the application server. For example, if the user interface is provided by a web browser, a web server would exist between the web browser and the application server. The web browser would send requests to the web server, and the web server would interact with application data in the database through the application server in order to generate a response to send to the web browser. In this scenario, the web browser and web server form a client/server pair, the web server and application server form another client/server pair, and the application server and database server form another client/server pair.

Multi-tiered enterprise applications, such as described above, are difficult to write because they are inherently distributed, generally transactional, and usually involve heterogeneous platforms. The application developers are expected to be well-versed in many subject areas. The application developers are expected to be able to understand the business problem and logic to solve the problem, group business logic into transactions, understand how to retrieve and update information in the database, and know how to use multi-processing capabilities to enhance performance of the application. The application developers must also take into account the type of clients to be supported and the communication protocol to be used between the client and server, the type of server and the application programmer interfaces (APIs) supported by the server, and the type of database management system (DBMS) used in managing the database.

Various technologies have been developed to ease the burden on developers. One such technology is Enterprise JavaBeans™ (EJB™) by Sun Microsystems, Inc. EJB™ provides a framework in which reusable business logic components can be created without understanding of the infrastructure or a concern for where the components will be deployed. This allows the developers to focus on writing business logic while delegating the other tasks to server vendors. EJB™ components can be deployed on top of existing transaction processing systems, including traditional transaction processing monitors, web servers, database servers, application servers, and so forth. EJB™ components are written in Java™ and are therefore platform-independent. This means that the components can be moved to a more scalable platform if necessary without having to rewrite the business logic code. A comparable technology to EJB™ is Microsoft Transaction Server (MTS), developed by Microsoft Corporation. MTS is based on the Component Object Model (COM), which is a middleware component model for Windows NT® operating system.

EJB™ components are typically referred to as enterprise beans or, simply, beans. The two main types of enterprise beans are called session bean and entity bean. A session bean is created by a client and usually exists for the duration of the client-server session. The session bean performs operations on behalf of the client, such as executing database reads and writes or performing calculations. Session beans can either be stateless or stateful, i.e., maintain conversational state across methods and transactions. Session beans can be transactional but are usually not recoverable following a system crash. Entity beans represent data maintained in a permanent database or other data store. An entity bean can be created by either inserting data directly into the database or by creating an object. A primary key identifies each instance of an entity bean. Entity beans are transactional and are recoverable following a system crash.

FIG. 1 shows an EJB architecture including an EJB server 2. The EJB™ server 2 is an application server that provides the environment necessary for execution of EJB™ applications. The EJB™ server 2 provides one or more EJB™ containers 4 (only one container is shown) for hosting enterprise beans. The EJB™ container 4 may be implemented as a physical entity, such as a multithreaded process within the EJB server 2, or as a logical entity that can be replicated and distributed across any number of systems and processes. The EJB™ container 4 hosts one or more enterprise beans 6 (only one enterprise bean is shown). The EJB™ container 4 is responsible for registering the bean, providing a remote interface for the bean, creating and destroying instances of the bean, checking security for the bean, managing the active state for the bean, and coordinating distributed transactions. If the enterprise bean 6 is an entity bean, the EJB™ container 4 may also optionally manage all persistent data within the bean.

The client 8 is the process that requires service from the enterprise bean 6. The EJB™ architecture allows for any kind of client program, such as Java™ servlet, JavaServer Pages™ (JSP), Java™ application, Java™ applet, and so forth. It should be noted that the client 8 does not have to be written in Java™.

A deployment descriptor object 10 contains information about the enterprise bean 6. Such information includes the type, name, implementation class, home interface, and remote interface of the enterprise bean 6. If the enterprise bean 6 is a session bean, the deployment descriptor object 10 states whether the bean is stateless or stateful and whether the session bean manages its own transactions. If the enterprise bean 6 is an entity bean, the deployment descriptor 10 states whether persistence is managed by the bean or by the container 4. If the enterprise bean 6 is an entity bean, the deployment descriptor object 10 also includes the primary key class of the entity bean. Remember that a primary key identifies each instance of an entity bean. The deployment descriptor object 10 also includes environment-related information, any resource manager connection factory references in the source code, any references in the source code to other beans, and any references in the source code to security roles.

The client 8 interacts with the enterprise bean 6 through two wrapper interfaces: EJBHome interface 12 and EJBObject interface 14. The EJBHome interface 12 and EJBObject interface 14 are generated by the container 4 at the time that the enterprise bean 6 is installed in the EJB™ container 4. The container 4 automatically registers the EJBHome interface 12 in a directory 16 using services of Java Naming and Directory Interface™ (JNDI) 18. JNDI is a standard API for interacting with naming and directory services. The client 8 can then use services of JNDI 18 to locate the EJBHome interface 12 of the enterprise bean 6 as needed. The EJBHome interface 12 provides access to the lifecycle management services for the enterprise bean 6. The client 8 can use the EJBHome interface 12 to create or destroy instances of the enterprise bean 6 or to find an existing instance of the enterprise bean 6 and retrieve it from the persistent data store 20.

The EJBObject interface 14 represents a client view of the enterprise bean 6. The EJBObject interface 14 provides access to the business methods within the enterprise bean 6.

As the client 8 invokes operations using the EJBHome interface 12 and the EJBObject interface 14, the EJB™ container 4 intercepts each method call and inserts management services. The rules governing management services for the enterprise bean 6 are defined in the deployment descriptor object 10. For each active instance of the enterprise bean 6, the EJB™ container 4 generates an instance context object which maintains information about the management rules and the current state of the instance. The context object is used by both the enterprise bean 6 and the container 4 to coordinate transactions, security, persistence, and other system services.

The client 8 communicates with the enterprise bean 6 using Remote Method Invocation (RMI). In RMI, the client 8 makes method calls to a stub object (not shown), which implements all the interfaces of the enterprise bean 6 and transparently delegates all method calls across the network to the enterprise bean 6. The enterprise bean 6 has a RMI remote interface. The EJB™ container 4 generates the EJBObject interface 14 from the RMI remote interface for the enterprise bean 6.

Many EJB applications embed fine-grained entity beans as remote objects. Fine-grained entity beans generally have several attributes and require many interactions with other objects. Indiscriminate use of fine-grained entity beans generally results in the client making excessive remote calls to the server. Such excessive remote calls can degrade the performance and scalability of the application.

One approach to reducing the number of remote calls made to the server involves caching and accessing the server data as local proxy objects on the client side. Many object-oriented database management systems and object-relational mapping systems, for example, use client caches of some kind to improve response time. Some of these systems also provide mechanisms for maintaining distributed objects. There are also software patterns that provide guidelines for hand-written optimization of client-side caching at the application design/development stage. See, for example, Martijn Res, “Reduce EJB Network Traffic with Astral Clones,” JavaWorld, December 2000. However, there are no known implementations that allow for efficient transparent caching and performance improvement in existing (ready-to-run or compiled) distributed applications.

### SUMMARY OF INVENTION

In one aspect, the invention relates to an automatic caching method for a distributed application having a client and a server. The automatic caching method comprises intercepting a call between the client and the server in order to collect information about objects accessed on the server during the call, prefetching data from the object based on collected information, placing data into a client cache, synchronizing marked calls with the server, and synchronizing the client cache with the server.

In one aspect, the invention relates to an automatic caching method for a distributed application having a client and a server. The automatic caching method comprises intercepting a call between the client and the server in order to collect information about objects accessed on the server during the call, prefetching data from the object based on collected information, placing data into a client cache, synchronizing marked calls with the server, synchronizing the client cache with the server, invalidating the client cache at the end of an activity, storing data in a proxy for the object that is locally accessible to the client, and invoking a method on the object in response to a request received by the proxy to invoke the method of the object.

In one aspect, the invention relates to an automatic caching method for an existing distributed application having a client and a server which comprises interposing a runtime between the client and the server. The runtime intercepts a call between the client and the server and has a capability to create a proxy for an object on the server. The automatic caching method further comprises collecting information about the object accessed on the server during an activity, prefetching data from the object based on collected information, and storing data in the proxy for the object that is locally accessible to the client.

In one aspect, the invention relates to an automatic caching system for a distributed application having a client and a server. The automatic caching system comprises a client runtime interposed between the client and the server. The client runtime has a capability to intercept a call between the client and the server in order to insert a service for collecting information about objects accessed on the server during the call. The automatic caching system further includes means for prefetching data from the objects on the server based on collected information and means for storing data fetched from the objects on the server in a memory locally accessible to the client.

In one aspect, the invention relates to a computer-readable medium having recorded thereon instructions executable by a processor. The instructions are for intercepting a call between a client and a server, collecting information about an object accessed on the server during an activity, prefetching data from the object based on collected information, and storing data in a proxy for the object that is locally accessible to the client.

In one aspect, the invention relates to a computer-readable medium having recorded thereon instructions executable by a processor. The instructions are for intercepting a call between a client and a server, collecting information about an object accessed on the server during an activity, prefetching data from the object based on collected information, storing data in a proxy for the object that is locally accessible to the client, creating the proxy from a proxy class, obtaining a reference to the object and storing the reference in the proxy, sending a request to the server to invoke a method of the client, interposing the proxy for the object such that the client accesses the proxy instead of the object, and synchronizing data stored in the proxy with data stored in the object.

In one aspect, the invention relates to an apparatus for a distributed application having a client and a server. The automatic caching method comprises means for intercepting a call between the client and the server in order to collect information about objects accessed on the server during the call, means for prefetching data from the object based on collected information, means for placing data into a client cache, means for synchronizing marked calls with the server, and means for synchronizing the client cache with the server.

Other aspects and advantages of the invention will be apparent from the following description and the appended claims.

### BRIEF DESCRIPTION OF DRAWINGS

FIG. 1 is a block diagram of an EJB application.

FIG. 2 shows a client runtime interposed between the client and server shown in FIG. 1 in accordance with one embodiment of the invention.

FIG. 3 shows a server runtime interposed between the client runtime of FIG. 2 and server of FIG. 2 in accordance with one embodiment of the invention.

### DETAILED DESCRIPTION

An optimization method and system consistent with the principles of the present invention uses interception for automatic caching and performance optimization of existing distributed applications. In the invention, an existing distributed application is analyzed and instrumented to intercept all method calls from the client side of the application to the server side. At runtime, the instrumented application caches data retrieved from the server side and monitors usage patterns of object attributes on the client side. These usage patterns are used to pre-fetch data from the server side.

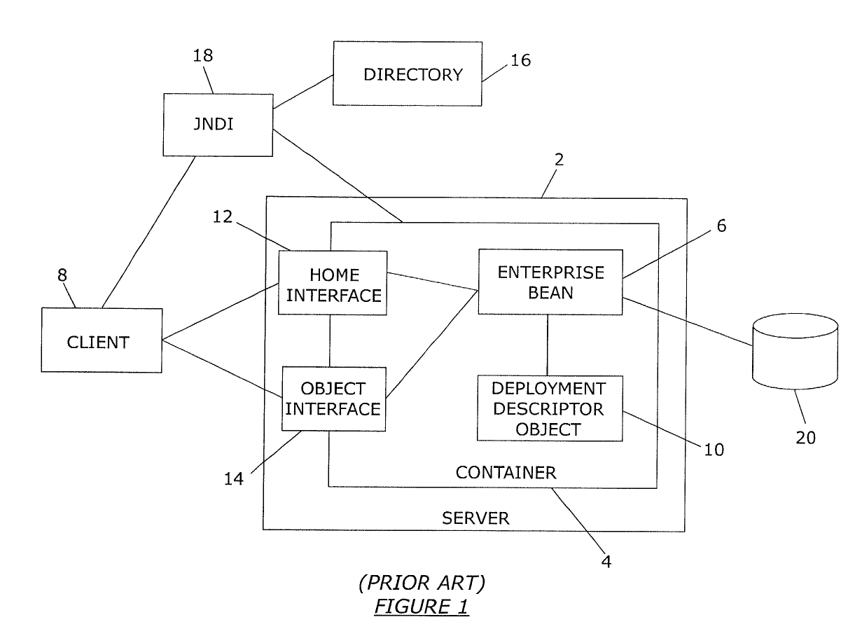

The invention is further described below using the EJB™ application illustrated in FIG. 1 as an example of an existing distributed application. However, it should be clear that the invention is not limited to EJB™ applications. In general, the invention is applicable to any distributed application.

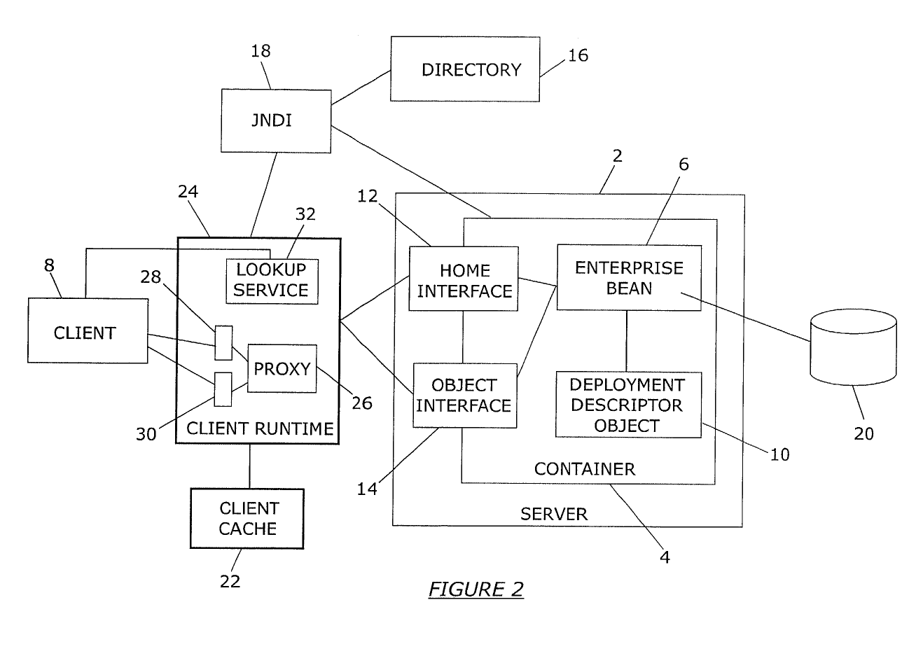

FIG. 2 shows an optimized version of the EJB™ application of FIG. 1 which incorporates an embodiment of the present invention. In this optimized version, a client cache 22 is provided on the client-side to cache data from the EJB™ server 2. In this optimized version, a client runtime 24 is interposed between the client 8 and the EJB™ container 4 and JNDI 18. The client runtime 24 is a library of routines that are bound to the client 8 while the client 8 is executing. The client runtime 24 includes a proxy 26, where the proxy 26 is a full or partial local copy on the client 8 which can delegate method calls to the server, if necessary. The proxy 26 has a home interface 28 and an object interface 30, just like the enterprise bean 6. In general, the client runtime 24 would include a proxy for each enterprise bean in the EJB™ container 4. U.S. patent application Ser. No. ______, entitled “Transparent Injection of Intelligent Proxies Into Existing Distributed Applications,” describes a process for generating proxies and injecting the proxies into existing distributed applications. The client runtime 24 also includes an internal lookup service 32 for finding the home interface 28 of the proxy 26.

The client runtime 24 intercepts all calls from the client 8 to the EJB™ container 4 and JNDI 18 in order to insert monitoring services. The client 8 is instrumented such that all calls normally made to the EJB™ container 4 and JNDI 18 now go to the client runtime 24. For an existing (compiled) application, the instrumentation process typically involves parsing the machine code (or bytecode) for the client 8 and replacing all calls to the EJB™ container 4 and JNDI 18 with calls to the client runtime 24. All these modifications can be made without changing the application semantic.

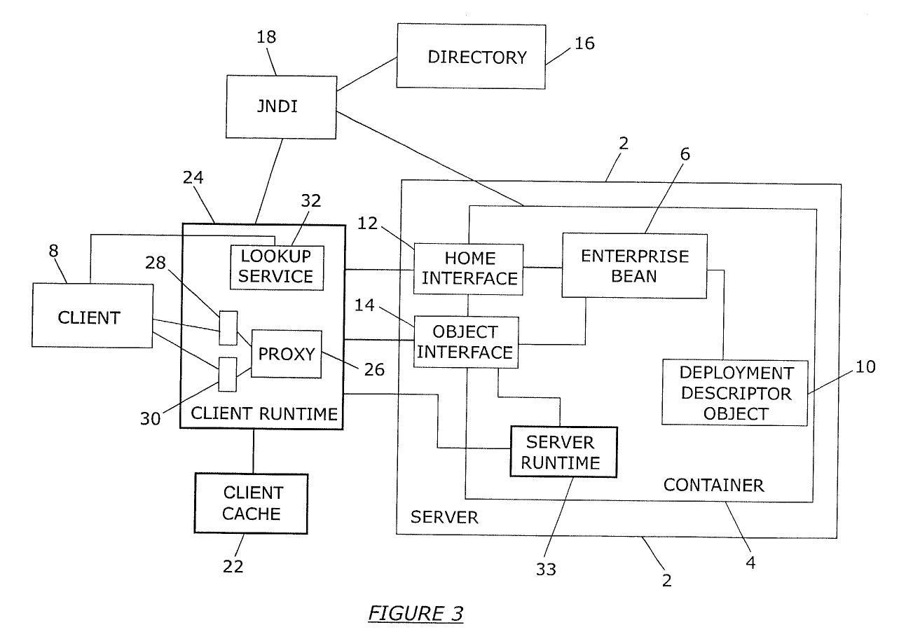

Referring to FIG. 3, a server runtime 33 is interposed between the client runtime 24 and the enterprise bean 6. In this way, the client runtime 24 interacts with the enterprise bean 6 through the server runtime 33. At runtime, the server runtime 33 synchronizes the data cached in the proxy 26 with the data in the enterprise bean 6. The server runtime 33 also provides other functions, such as invoking business methods on the enterprise bean 6 on behalf of the proxy 26, collecting and sending changes made to the enterprise bean 6 to the proxy 26, and returning the result of a method call to the enterprise bean 6. These functions may be implemented in a session bean that is included in the server runtime 33. The session bean may be deployed in the EJB™ container 4 with the enterprise bean 6.

At runtime, the client runtime 24 intercepts all calls for locating the EJBHome interface 12 of the enterprise bean 6 through JNDI 18. Instead of returning the EJBHome interface 12 of the enterprise bean 6, the client runtime 24 obtains the home interface 28 of the proxy 26 using the internal lookup service 32 and returns the home interface 28 to the client 8. Before the client 8 returns the home interface 28 to the client 8, the client runtime uses JNDI 18 to obtain the EJBHome interface 12 of the enterprise bean 6 and includes a reference to the EJBHome interface 12 as an internal variable in the home interface of the proxy 26. Once the client 8 receives a reference to the home interface 28, the client 8 can use the home interface 28 to create an instance of the proxy 26, destroy an instance of the proxy 26, or find an instance of the proxy 26. All this happens transparently so that the client 8 is fooled into thinking that it is actually interacting with the EJBHome interface 12 of the enterprise bean 6.

When the client 8 thinks it is requesting for an instance of the enterprise bean 6, the client 8 is actually requesting for an instance of the proxy 26. The client runtime 24 intercepts the call and checks if the instance of the proxy 26 exists in the client cache 22. If the instance of the proxy 26 exists in the client cache 22, the client runtime 24 returns the proxy instance to the client 8. If the proxy instance does not exist in the client cache 22, the client runtime 24 creates a proxy instance and returns the proxy instance to the client 8. The client runtime 24 also stores a reference to the newly-created proxy instance in the client cache 22. Before the client runtime 24 returns the proxy instance to the client 8, the client runtime 24 uses the EJBHome interface 12 to find an instance of the enterprise bean 6. If an instance of the enterprise bean 6 is found, the client runtime 24 includes a reference to the instance of the enterprise bean 6 in the proxy instance. If the instance of the enterprise bean 6 is not found, the client runtime 24 uses the EJBHome interface 12 to create an instance of the enterprise bean 6 and includes a reference to the instance of the enterprise bean 6 in the proxy instance.

Attributes of the enterprise bean 6 are obtained by calling get (accessor) methods on the bean. When the client 8 invokes a get method for an attribute of the enterprise bean 6, the client runtime 24 intercepts the method call collects information about the requested attribute. The client runtime 24 then allows the proxy 26 to process the method call and return the cached value to the client 6. If the attribute is not cached in the proxy 26, the client runtime 24 sends a request to the EJB™ server 2 for the attribute.

Similarly, attributes of the enterprise bean 6 are set by calling set (mutator) methods on the bean. When the client 8 invokes a set method for an attribute of the enterprise bean 6, the client runtime 24 intercepts the method call and collects info about the attribute being changed by the client 8. The client runtime 24 then allows the proxy 26 to cache the attribute. The cached value is later sent to the EJB™ server 2, typically when the next remote (“business”) method is invoked.

When the client 8 calls a business method of the enterprise bean 6, the client runtime 24 intercepts the call in order to collect information about the attributes involved in the method call and to allow client-server cache synchronization. After collecting information, the client runtime 24 sends a message to the server runtime 33 to invoke the intercepted business method call on the enterprise bean 6. Prior to invoking the business method, the server runtime 33 updates the attributes of the enterprise bean 6 with the changed attributes of the proxy 26. Then the server runtime 33 invokes the business method on the enterprise bean 6. The server runtime 33 collects and sends all the changes made to the enterprise bean 6 (via the business method call) to the proxy 26, along with the result of the original business method call. It should be noted that the EJB™ application will generally have many bean instances, and the client runtime 24 will generally have a corresponding number of proxy instances. The server runtime 33 associates a proxy instance with a bean instance using the bean reference stored in the proxy instance.

When a proxy instance is newly created, the proxy instance does not contain the attribute values from the corresponding bean. As the client 8 requests for attributes and invokes business methods, the client runtime 24 intercepts the request and collects information about attributes involved in the request as described above. The client runtime 24 uses the collected information to build a usage description of the objects accessed by the client 8. The usage description identifies the parts of the objects that the client 8 needs. The next time the client 8 asks for an object for which a usage description has been derived, the client runtime 24 creates an instance of the object as described above and fetches attributes from the object into the proxy, even before the client 8 requests for the attributes. Typically, the attributes are fetched in a single network call by sending a single fetch request to the server runtime 33. Further, the attributes are locally accessible to the client 8. These have the effect of reducing the number of client-server roundtrips in the application.

The client runtime 24 may also collect additional information and store them as artificial attributes of the intercepted objects as needed. Examples of artificial attributes include server-side identity of the original EJB™ objects (primary keys for the EJB™ entity objects), EJB™ handle, EJB™ home handle, EJB™ metadata, and remote reference to the original EJB™ object. The server runtime 33 uses the server-side identity to match the proxy instance in the client runtime 24 with a bean instance in the EJB™ container 4 during cache synchronization. The EJB™ handle, EJB™ home handle, and EJB™ metadata objects are cached as needed in the client runtime 24 to reduce the number of (remote) calls between the client and the server. These handles are needed to invoke lifecycle management services on the bean and to discover information about the environment of the bean. It should be noted that these artificial attributes may differ based on the underlying distributed technology used in the application.

Caching typically starts at the beginning of some (client-side originated) client activity and ends at the end of this activity. A client activity usually represents a business task performed as a single step within the context of the application business process. In a web-based distributed application, a common example of such client activity is a set of computations performed by the application upon one individual request from the end-user web browser. The proxy instances created during the client activity are invalidated after the end of the client activity. The client 8 makes a call to the client runtime 24 to invalidate the proxy instances. After the end of the client activity, the client cache 22 is invalidated as needed before its first usage in the next client activity. Those skilled in the art will appreciate that only part of the cache may be invalidated, i.e., the cache is only partially invalidated before usage in the next client activity. This forces any necessary client-server synchronization before the next client activity is executed. The client-server synchronization may include synchronizing marked calls with the server, and synchronizing the client cache with the server.

The invention provides advantages in that it allows existing (ready-to-run) distributed applications to run faster by automatically caching server data and prefetching server data based on object usage. The data cached in the proxy can be manipulated by the client. The changed data typically remains in the proxy until the proxy receives a request to invoke a business method of a remote object. At this time, the changed data is sent to the server runtime, which updates the remote object with the data and invokes the business method on the remote object. This scheme ensures that the remote object has the latest data before the business method is processed. This scheme also minimizes the number of data roundtrips between the client and server because a call is not made to the server for each attribute changed by the client. The client runtime intercepts all calls made to the proxies in order to collect information about object usage. This information is then used to prefetch data into the proxies.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

what is claimed is:

1. An automatic caching method for a distributed application having a client and a server, comprising:
intercepting a call between the client and the server in order to collect information about objects accessed on the server during the call;
prefetching data from an object on the server based on collected information;
placing data into a client cache;
synchronizing marked calls with the server; and
synchronizing the client cache with the server.

2. The automatic caching method of claim 1, further comprising:
invalidating the client cache at the end of an activity.

3. The automatic casting method of claim 1, further comprising:
storing data in a proxy for the object that is locally accessible to the client.

4. The automatic caching method of claim 3, wherein storing data in the proxy comprises creating the proxy from a proxy class.

5. The automatic caching method of claim 4, wherein creating the proxy comprises storing a reference to the proxy in the client cache.

6. The automatic caching method of claim 4, wherein creating the proxy comprises storing a reference to the object inside the proxy.

7. The automatic caching method of claim 5, further comprising:
invalidating the proxy at the end of an activity.

8. The automatic caching method of claim 5, further comprising:
partially invalidating the client cache at the end of an activity.

9.The automatic caching method of claim 1, further comprising:
invoking a method of the object in response to a request received by a proxy to invoke the method of the object.

10. The automatic caching method of claim 9, wherein invoking the method of the object comprises synchronizing data stored in the proxy with data in the object.

11. The automatic caching method of claim 1, wherein collected information comprises object attributes requested by the client during the call.

12. The automatic caching method of claim 1, wherein collected information comprises information for accessing an interface of the object.

13. An automatic caching method for a distributed application having a client and a server, comprising:
intercepting a call between the client and the server in order to collect information about objects accessed on the server during the call;
prefetching data from an object on the server based on collected information;
placing data into a client cache;
synchronizing marked calls with the server;
synchronizing the client cache with the server;
invalidating the client cache at the end of an activity;
storing data in a proxy for the object that is locally accessible to the client; and
invoking a method of the object in response to a request received by the proxy to invoke the method of the object.

14. An automatic caching method for an existing distributed application having a client and a server, comprising:
interposing a runtime between the client and the server which intercepts a call between the client and the server, the runtime having a capability to create a proxy for an object on the server;
collecting information about the object accessed by the client during an activity;
prefetching data from the object based on collected information; and
storing data in the proxy for the object that is locally accessible to the client.

15. The automatic caching method of claim 14, wherein collected information comprises object attributes accessed by the client during an activity.

16. The automatic caching method of claim 14, wherein interposing the runtime between the client and the server comprises instrumenting the client such that a request normally sent to the server is directed to the runtime.

17. The automatic caching method of claim 14, wherein the runtime has a client portion that runs in the same machine as the client and a server portion that runs in the same machine as the server.

18. The automatic caching method of claim 17, further comprising:
sending a request to the server portion by the client portion to synchronize data stored in the proxy with data in the object.

19. The automatic caching method of claim 17, further comprising:
sending a request to the server portion to invoke a method of the object on behalf of the proxy.

20. The automatic caching method of claim 19, further comprising:
synchronizing data stored in the proxy with the data in the object by the server portion prior to invoking the method of the object.

21. An automatic caching system for a distributed application having a client and a server, comprising:
a client runtime interposed between the client and the server, the client runtime having a capability to intercept a call between the client and the server in order to insert a service for collecting information about objects accessed on the server during the call;
means for prefetching data from the objects on the server based on collected information; and
means for storing data fetched from the objects on the server in a memory locally accessible to the client.

22. The automatic caching system of claim 21, wherein the client runtime comprises a plurality of proxies for caching the data fetched from the server.

23. The automatic caching system of claim 22, wherein each of the proxies is associated with an object on the server.

24. The automatic caching system of claim 23, further comprising:
a server runtime interposed between the client runtime and the server which synchronizes data cached in the proxies with data in the objects.

25. A computer-readable medium having recorded thereon instructions executable by a processor, the instructions for:
intercepting a call between a client and a server;
collecting information about an object accessed on the server during an activity;
prefetching data from the object based on collected information; and
storing data in a proxy for the object that is locally accessible to the client.

26. The computer-readable medium of claim 25, further comprising:
instructions for creating the proxy from a proxy class.

27. The computer-readable medium of claim 26, further comprising;
instructions for obtaining a reference to the object and storing the reference in the proxy.

28. The computer-readable medium of claim 25, further comprising:
instructions for sending a request to the server to invoke a method of the object.

29. The computer-readable medium of claim 25, further comprising:
instructions for interposing the proxy for the object such that the client accesses the proxy instead of the object.

30. The computer-readable medium of claim 25, further comprising:
instructions for synchronizing data stored in the proxy with data in the object.

31. A computer-readable medium having recorded thereon instructions executable by a processor, the instructions for:
intercepting a call between a client and a server;
collecting information about an object accessed on the server during an activity;
prefetching data from the object based on collected information;
storing data in a proxy for the object that is locally accessible to the client;
creating the proxy from a proxy class;
obtaining a reference to the object and storing the reference in the proxy;
sending a request to the server to invoke a method of the object;
interposing the proxy for the object such that the client accesses the proxy instead of the object; and
synchronizing data stored in the proxy with data in the object.

32. An apparatus for a distributed application having a client and a server, comprising:
means for intercepting a call between the client and the server in order to collect information about objects accessed on the server during the call;
means for prefetching data from an object on the server based on collected information;
means for placing data into a client cache;
means for synchronizing marked calls with the server; and
means for synchronizing the client cache with the server.
